(19) United States
(12) Patent Application Publication
(10) Pub. No.: US 2025/0375681 A1
(43) Pub. Date: Dec. 11, 2025

(54) STIPPLED PICKLOID OR CUCUMBIC GRIP APPARATUS

(71) Applicant: Raphael Luborsky Samost, Marlton, NJ (US)

(72) Inventor: Raphael Luborsky Samost, Marlton, NJ (US)

(21) Appl. No.: 18/736,342

(22) Filed: Jun. 6, 2024

(51) Int. Cl. A63B 60/14; A47G 23/02; B25G 1/10

(52) U.S. Cl. CPC A63B 60/14; A47G 23/0241; A47G 23/0266; B25G 1/102

(57) ABSTRACT

A stippled pickloid or cucumbic grip apparatus generally includes a body portion having a proximal end, an aperture thereat, a distal end, a pocket extending through at least a portion of the body toward the distal end, and a plurality of stipples disposed around the exterior of the body portion. The apparatus is shaped to resemble a pickle or its pre-pickled predecessor, the cucumber, and offers at least stipples with the optional include of additionally raised features to improve haptics, comfort, and overall tactility. Generally, the aperture and pocket are shaped to receive variously sized and shaped handles and other items that would benefit from increased grippability. The apparatus may also include fluid channels, an affixation band, a valve, a compressive lining within the pocket, and a plurality of additional raised features resembling ingredients that may be added to the pickling process which would further increase tactility and haptics.

### BACKGROUND OF THE INVENTION

Various types of handles, grips, and covers exist in the art and pertain to an incredibly wide array of instruments, appliances, utensils, equipment, and other apparatuses that are described as reducing hand fatigue or providing increased ease of use. These handles, grips, and covers are typically defined as being ergonomic as they relate to, or are designed for, efficiency and comfort in a given working environment, though many differ in how they effect the work environment and the human operating therein. For instance, one reference claims an improved ergonomic handle having utility due to its substantially elliptical cross-section in a first plane forming a dihedral angle with respect to a second plane wherein the minor and major axes are specifically sized and located relative to one another. Another reference claims a thermoplastic grip that wraps around a given item and must be submerged in boiling water until deformable so that an individual’s hand may impress upon it and create a user-specific handle that will cool into a stable and semi-rigid grip.

A myriad of other references include titles claiming ergonomic handles, grips, or grip covers for tools, knives, drills, appliances, shavers, scrapers, pry bars, shafts, swinging implements, rods, and additional items. These have included cross-handle designs, dual molded handle compositions having unidirectional striations or lines, multi-angled handles allowing for alternative angular gripping, specifically contoured handles having anatomical hand-matching curvature, handles having a thumb support/recess portion extending outwardly to allow for it to sit in a partially flexed position, handles having multi-dimensional gripping regions, and numerable additional designs for both general and specific-instrumental use. Alternative means of people creating their own ergonomic, or otherwise improved, handles and grips are also known in the art as users may try solving issues of discomfort and ineffective designs with tape wraps, molded substances, foam wraps, by wearing gloves, and/or by covering the handle/grip in a variety of chemical substances to soften or improve grippability.

Online products are typically geared towards vehicle handles (i.e. bicycles, motorcycles, scooters) with some of these molded plastic grips including ribbed grips or contour ribbed grips, waffle grips, finger or bubble grips, and dimpled grips. Additionally, there are grips with fins and flanges, brake lever grips, tapered grips, bumpy pencil grips having an expanded triangular prismatic shape, and a variety of combined versions thereof. When it comes to pickle, and cucumber, shaped objects online there are a myriad that include carved wooden pickles, pickle ornaments, pickle writing implements, pickle stress relievers, glass pickles, musical pickles, pickle tumblers, pickle confetti, and plenty of other similarly visualized items. However, these items do not possess both a plurality of stipples typically seen on cucumbers/pickles and the capability of improving grippability and/or tactility of an item through a removably securable apparatus.

Ergonomic studies have shown that poor, uncomfortable, and/or inefficient angling of the wrist and forearm can, in certain circumstances especially given consistent use, result in painful and/or crippling disorders (i.e. carpal-tunnel syndrome, tennis elbow, or other cumulative trauma disorders). Wrist injuries may arise when it is placed in a radially deviated state or stressed (such as bent or rotated) position, as opposed to a neutral one, when using standard right angle handles with a consistent twisting or turning motion, which continuously puts strain on the already stressed wrist. As it relates to rackets, a design has been introduced recently wherein the rim appears to be equivalent to regular rackets, but one side of the shaft (or throat) appears slightly more curved as it leads into an entirely arced handle region. The creators state that the addition of a curved handle and partially curved body makes reaching balls at near ground level becomes more effective while making volleying easier as there is no need to adjust a user’s wrist angle, which also helps to prevent tennis elbow.

In consideration of the kinesiology of dynamic hand, wrist, and arm movement as well as the physiology of joints and musculature of the human anatomy, what is needed in the art is a removably securable conformable grip, handle, or cover that can be installed onto most hand-held objects thereby offering improved tactility and better accommodating a user’s hand, wrist, and arm in general when gripping the object both at a resting state and during work.

### FIELD OF THE INVENTION

The present invention relates to grips and handle covers for tools, athletic equipment, and disposable every day items, and more particularly, to a universal grip or handle cover that is removably securable to an item thereby allowing the user increased surface tactility and comfort while operating, working, or using said items.

### SUMMARY OF THE INVENTION

The general purpose of the stippled pickloid or cucumbic grip apparatus, described subsequently in greater detail, is to address deficiencies in the aforementioned handle and grip designs by providing a improved grip apparatus which is not anticipated, rendered obvious, suggested, or even implied by prior art, either alone or in combination thereof.

According to one contemplated embodiment, the present invention is a grip or handle cover resembling the shape and overall appearance of a pickle or cucumber, wherein it comprises an axially elongated body having a plurality of stipples across its surface and a body portion that may be straight or may curve, arc, or bend in some places and/or may include a bulbous end. Similar to how real-life pickles and cucumbers are not of uniform shape or description, so too may the present invention offer customizable designs and varieties that best align with the needs of each user while also offering improved grippability and in some cases ergonomics in relation to the task, work, or operation of the specific item to which the present invention may removably secured.

Given the aforementioned anatomical and ergonomical concerns, having such a stippled pickloid or cucumbic grip apparatus described herein capable of converting most any typical handle into one providing a relaxed wrist orientation is advantageous to athletes, everyday workers, and hobbyists alike. The stippled pickloid or cucumbic grip apparatus is envisioned as reducing user stress and increasing performance efficiency while providing increased comfort and providing improved range and quality of operator motion through its unique shape, customizable features and orientation, as well as improved tactility and grippability.

A stippled pickloid or cucumbic grip at the least includes two ends, an aperture disposed about at least one of them for insertion of an item, a body portion having a pocket extending partially or entirely therethrough, and an exterior surface having a plurality of stipples. This aperture is not intended to be X-shaped. Shaped as its name infers, the present invention may be visualized as a straight or curved ellipsoid, obround capsule, or other shape that resembles a pickle and/or cucumber having at least one open end leading into a pocket extending through at least a part of the body portion wherein a parallelepiped, obround, cylindrical, or prismatic item (or components thereof) may be housed, such as the handle of a racket, paddle, or racquet as well as an appliance handle, handlebar, can, or bottle. Alternatively, the present invention contemplates embodiments wherein a variety of items possessing different cross-sections may be housed therein, with non-limiting examples thereof including circular (i.e. baseball bats), rectangular (i.e. hockey sticks), pentagonal, hexagonal (i.e. lacrosse sticks), octagonal (i.e. tennis rackets), as well as those items having an additionally protruding butt (i.e. baseball bats and tennis rackets). In consideration of the fact that many of the aforementioned items listed as capable of being housed within the present invention are of varying sizes, the pocket may additionally comprise a compressive sleeve lining, which may be formed of polymeric or elastomeric materials, that exerts at least a minimal force upon said item thereby keeping it stationary and operationally engaged within the pocket while also allowing a user to twist or rotate it around the item.

While the materiality of the present invention is contemplated as being comfortably conformable polymers that deform under pressure then reassume their initial shape while resisting degradation and corrosion throughout numerous uses. Additionally, synthetic polymers, elastomers, hard polymers, and alternative materials having similar contemplated characteristics are also considered as within the scope of the present invention. Additionally contemplated are insulating materials capable of keeping an inserted item at its current temperature for as long as possible, heat-resistant materials allowing for use with pots and pans on a stovetop, and water/sweat-resistant (such as non-slip or hydrophobic) materials that assure non-slip grip of the present invention. In an additionally contemplated embodiment, the present invention may also comprise a plurality of extruded fluid channels for the fluids captured on its surface or within the pocket to be removed while avoiding disruption in use.

Various embodiments of the present invention, while based on and resembling natural cucumbers and pickles having arbitrarily placed stipples, are also contemplated as including specifically and intentionally arranged pluralities of stipples in repeating patterns or designs, as well as customized patterns or designs. It is contemplated that additional embodiments may have said stipples and/or additionally raised features organized in specific tractive patterns that may include parallel, perpendicular, or offset lines, or lines forming spiral, helical, diamond, combinations thereof, or alternative patterns. For instance, a contemplated embodiment may include a user sending an image, scan, and/or size preference of their hand thereby allowing the formation of stipples and/or additionally raised features around said shape, within said shape, in between the digits thereof, or with a pattern/design best suited therefor.

Additionally contemplated embodiments of the present invention may include the distal end of the apparatus having a valve (that may resemble a stem) to allow for the ingress and/or egress of fluids, fluid channels along the body that allow for the draining thereof toward the distal end, a flat portion to allow for the freestanding of the apparatus (and item therein), a secondary aperture connected to the pocket, a band about the proximal end allowing for permanent affixability, additional raised features along the exterior surface interspersed with the plurality of stipples, increased customizability of colors and aforementioned features, or a combination thereof. These additional raised features, contemplated as being sized and shaped differently than the plurality of stipples to increase tactility and grippability, are intended to resemble ingredients present during the pickling process, such as pepper/peppercorns, vegetable bits, spices, flakes, herbs, garlic, chilies, etc. It is contemplated that embodiments discussed and considered herein may be formed of a single polymer or a combination of polymers such that apparatus formed is comfortably conformable to the hand(s) of a user wherein application of force thereby may allow for at least a modicum of yielding of the material within the user’s grip.

Thus, has been broadly outlined the more important features of the present stippled pickloid or cucumbic grip apparatus so that the detailed description thereof that follows may be better understood and in order that the present contribution to the art may be better appreciated.

Objects of the present stippled pickloid or cucumbic grip apparatus, along with various novel features that characterize the invention are particularly pointed out in the claims forming a part of this disclosure. For better understanding of the stippled pickloid or cucumbic grip apparatus, its operating advantages and specific objects attained by its uses, refer to the accompanying drawings and description.

### BRIEF DESCRIPTION OF THE DRAWINGS

### FIGURES

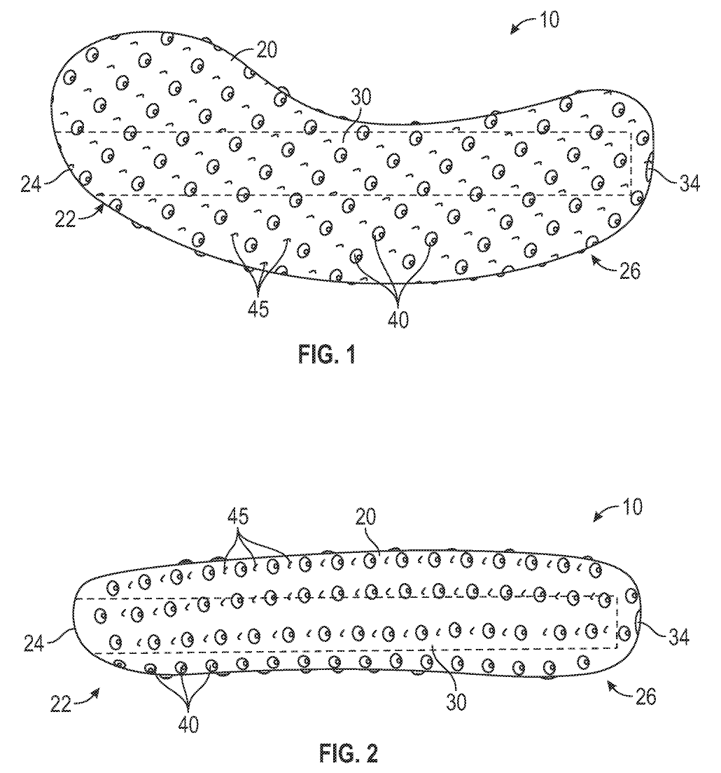

FIG. 1 is an isometric view of an example embodiment of the stippled pickloid or cucumbic grip apparatus.

FIG. 2 is an isometric view of an example embodiment of the stippled pickloid or cucumbic grip apparatus.

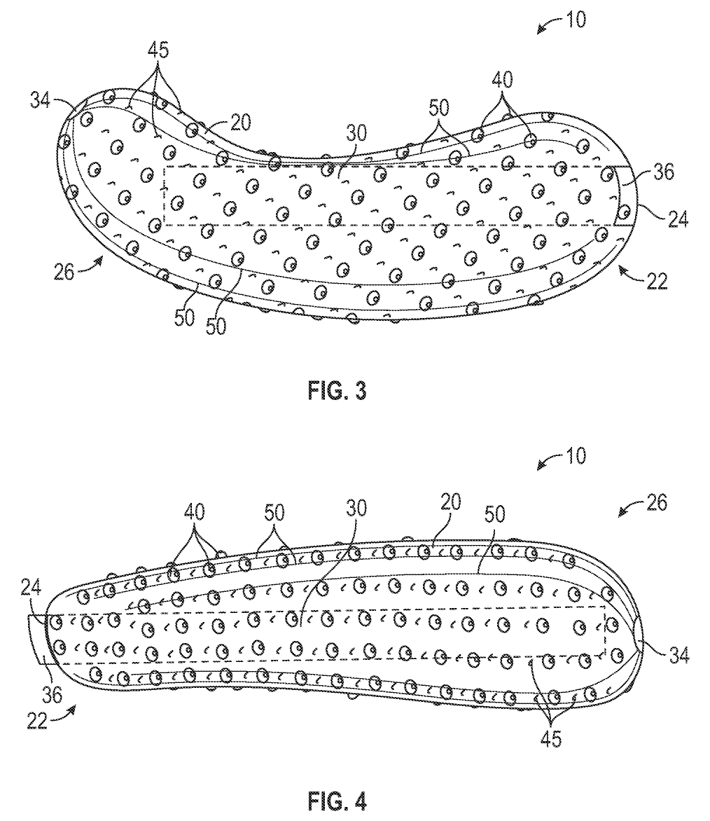

FIG. 3 is an isometric view of an example embodiment of the stippled pickloid or cucumbic grip apparatus.

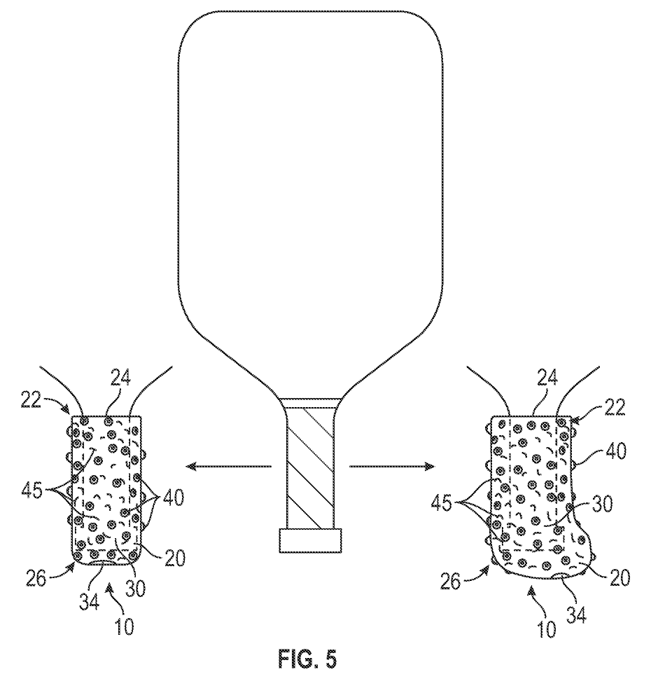

FIG. 4 is an isometric view of an example embodiment of the stippled pickloid or cucumbic grip apparatus.

FIG. 5 is an isometric view of an example embodiment of the stippled pickloid or cucumbic grip apparatus in use with a pickleball paddle.

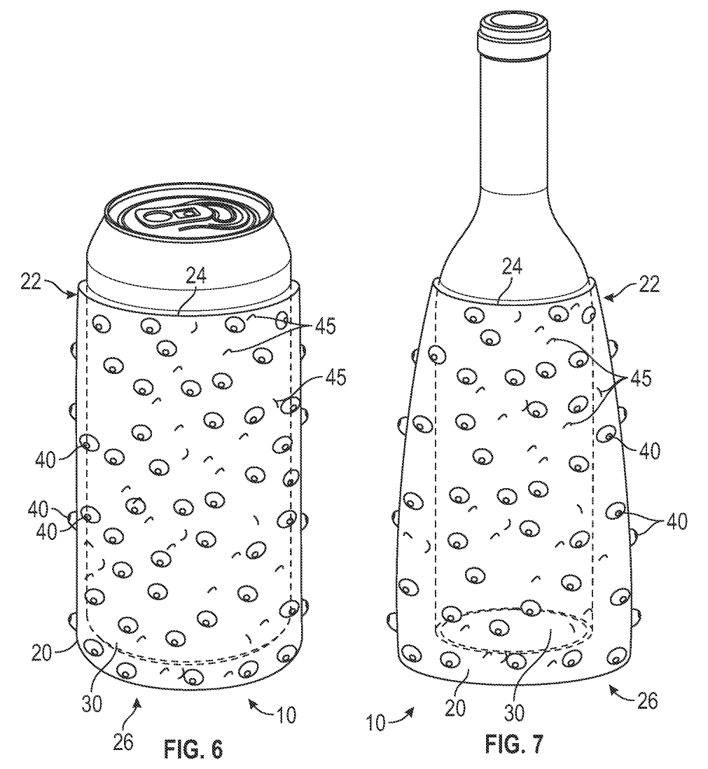

FIG. 6 is an isometric view of an example embodiment of the stippled pickloid or cucumbic grip apparatus in use with can.

FIG. 7 is an isometric view of an example embodiment of the stippled pickloid or cucumbic grip apparatus in use with a bottle.

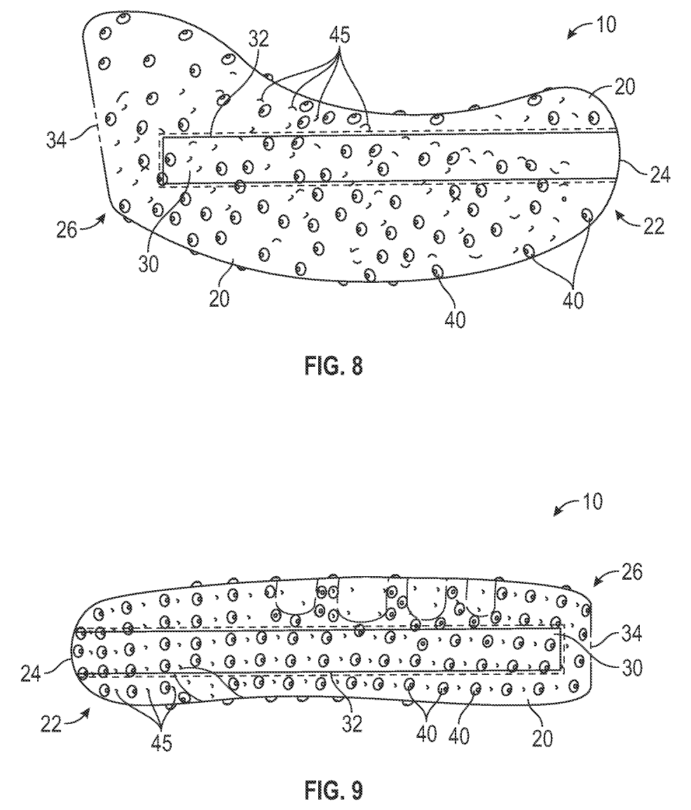

FIG. 8 is an isometric view of an example embodiment of the stippled pickloid or cucumbic grip apparatus.

FIG. 9 is an isometric view of an example embodiment of the stippled pickloid or cucumbic grip apparatus.

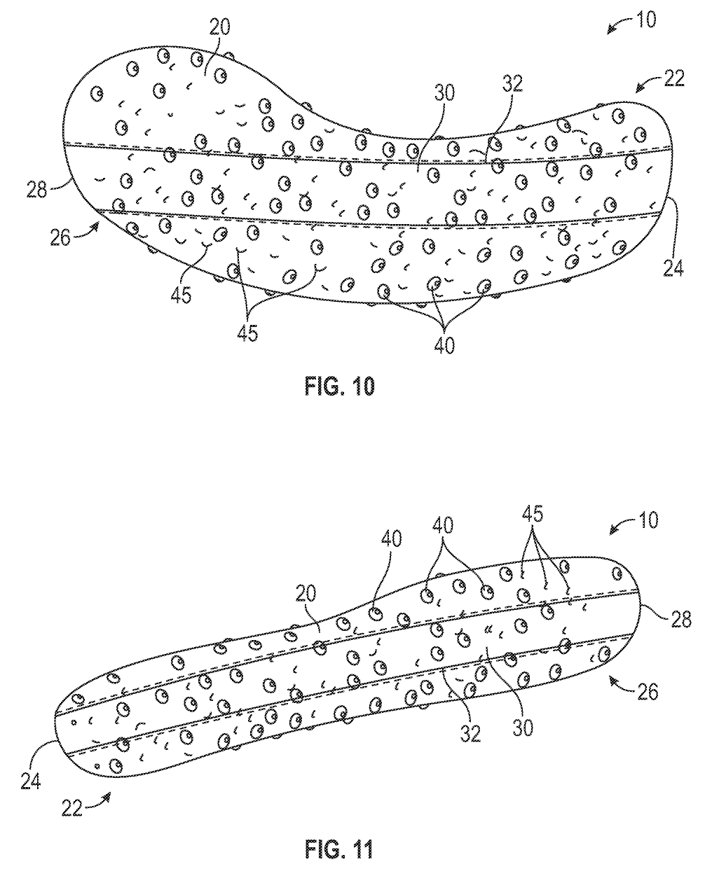

FIG. 10 is an isometric view of an example embodiment of the stippled pickloid or cucumbic grip apparatus.

FIG. 11 is an isometric view of an example embodiment of the stippled pickloid or cucumbic grip apparatus.

### DETAILED DESCRIPTION OF THE DRAWINGS

With reference now to the drawings, and in particular FIGS. 1 through 11 thereof, examples of the instant stippled pickloid or cucumbic grip apparatus employing the aforementioned principles and concepts, generally designated by the reference number 10, will be described.

Referring to FIGS. 1 through 4, an example embodiment of stippled pickloid or cucumbic grip apparatus 10 is depicted having body 20 with proximal end 22 and distal end 26 wherein first aperture 24 disposed about proximal end 22 gives access to pocket 30 located throughout most of the length of the interior of body 20. Valve 34 is shown about distal end 26 and allows for the ingress or egress of fluids. While all figures depicted and contemplated herein resemble pickles, or its pre-pickled predecessor cucumbers, differences abound, such that the shape of FIGS. 1 and 3 resemble a curved ellipsoid while FIGS. 2 and 4 resemble an oblong capsule. However, as with these fruits in real life, their shapes and formations are extremely varied and contemplated as within the scope of the present application. As with all embodiments contemplated herein, each stippled pickloid or cucumbic grip apparatus 10 includes a plurality of stipples 40 in such a manner as to offer a user improved haptics, comfort, and overall tactility. Additionally depicted, though not necessarily present on all embodiments are a plurality of additional raised features 45, which may resemble ingredients present during pickling, such as peppercorns, flakes, herbs, spices, garlic, and/or bits of additional ingredients. While plurality of stipples 40 and plurality of additional raised features 45 are shown to be divided into orderly lines, additional figures show them as randomly or arbitrarily assorted.

Referring only to FIGS. 3 and 4, while similar to FIGS. 1 and 2 in nearly all respects, these figures include the presence of band 36, which allows users to permanently affix stippled pickloid or cucumbic grip apparatus 10 to a piece of equipment or whatever has been placed within pocket 30. Band 36 may be affixable from its position within stippled pickloid or cucumbic grip apparatus 10 or may be capable of flipping up thereby extending beyond proximal end 22 and affixing to the item inserted into pocket 30 once in that orientation. Additionally, FIGS. 3 and 4 depict plurality of fluid channels 50 that give any build-up of fluids upon the exterior of body 20 a pathway towards distal end 26 and valve 34 thereby allowing for drainage.

Referring to FIG. 5, stippled pickloid or cucumbic grip apparatus 10 is depicted as having a pickleball or paddleball racket handle inserted into pocket 30 having an additional bowed out space about the portion of pocket 30 closest to distal end 26 such that a handle having a butt, or extended lowest portion, may be comfortably housed therein.

Referring to FIGS. 6 and 7, stippled pickloid or cucumbic grip apparatus 10 is depicted as having a can or bottle inserted into pocket 30 wherein the material composition of body 20 is contemplated as being a polymer, or blend thereof, having insulating qualities. However, any condensation or build of fluids may be drainable from stippled pickloid or cucumbic grip apparatus 10 via valve 34 (not shown). Unlike in FIG. 6, stippled pickloid or cucumbic grip apparatus 10 depicted in FIG. 7 shows at proximal end 22 of body 20 tapering toward the bottle housed within pocket 30 and extending therefrom.

Referring to FIGS. 8 and 9, stippled pickloid or cucumbic grip apparatus 10 is depicted as possessing all the same elements as were depicted in the previous figures, however, distal end 26 is now depicted as being flat and therefore capable of standing upright while compressive lining 32 has been added within pocket 30 such that any item place therein will have an additional amount of force exerted upon it thereby keeping it tautly engaged and stationary within stippled pickloid or cucumbic grip apparatus 10. Additionally, as it relates solely to FIG. 9, plurality of stipples 40 are organized and arranged on body 20 to form a custom outline of a user’s specific handgrip thereby allowing for personalization of stippled pickloid or cucumbic grip apparatus 10.

Referring lastly to FIGS. 10 and 11, stippled pickloid or cucumbic grip apparatus 10 is depicted as possessing second aperture 28 about distal end 26 and no valve 34 wherein body 20 may occupy a space along any item inserted therethrough, and not just an end of the item, while compressive lining 32 assists in maintaining the preferred placement upon said item.

What is claimed is:

1. A stippled pickloid or cucumbic grip apparatus comprising:
a proximal end;
a first aperture disposed about the proximal end;
a body portion;
a distal end;
a pocket extending from the proximal end aperture through the body portion to about the distal end; and
an exterior surface having a plurality of stipples;
wherein the stipples are disposed around the exterior of the apparatus being arranged in such a manner as to offer a user improved haptics, comfort, and overall tactility.

2. The stippled pickloid or cucumbic grip apparatus of claim 1 wherein the apparatus is shaped like a pickle, or its pre-pickled predecessor a cucumber.

3. The stippled pickloid or cucumbic grip apparatus of claim 2 wherein the apparatus is shaped as a straight or curved ellipsoid, a straight capsule, or a straight or curved oblong capsule.

4. The stippled pickloid or cucumbic grip apparatus of claim 3 wherein the portion of the distal end furthest from the proximal end is flat.

5. The stippled pickloid or cucumbic grip apparatus of claim 2 wherein the apparatus may be straight, curved, or arched to resemble the average norm of the variety of shapes common to actual pickles or cucumbers within at least one standard deviation of the curvature of the average pickle or cucumber.

6. The stippled pickloid or cucumbic grip apparatus of claim 1 wherein the at least one aperture and pocket extending therefrom is shaped and sized to conformably house cylindrical, obround capsule, and prismatic items or components thereof.

7. The stippled pickloid or cucumbic grip apparatus of claim 6 further comprising a polymeric or elastomeric compressive sleeve lining the pocket wall such that any item, or component thereof, placed therein will have at least a minimum of force exerted upon it thereby tautly engaging it and keeping it in stationary operational engagement.

8. The stippled pickloid or cucumbic grip apparatus of claim 1 further comprising a body portion, and pocket therein, having an additional bowed out space about the distal end such that the handle butt of a racket, paddle, bat, racquet, or other item is capable of being comfortably housed within the apparatus.

9. The stippled pickloid or cucumbic grip apparatus of claim 1 further comprising:
a plurality of fluid channels disposed about the body portion oriented to run from the proximal end to the distal end;
wherein any bodily fluids excreted by a user will enter each of the plurality of fluid channels and run along the body portion to the distal end, where such fluid shall drop from the apparatus.

10. The stippled pickloid or cucumbic grip apparatus of claim 1 wherein the body portion is composed of polymeric, synthetic, or elastomeric material that is both comfortably conformable to an exerted force and resistant to corrosion or degradation.

11. The stippled pickloid or cucumbic grip apparatus of claim 1 wherein the plurality of stipples is arranged arbitrarily.

12. The stippled pickloid or cucumbic grip apparatus of claim 1 wherein the plurality of stipples is arranged in a specific tractive pattern, such as helical, diamond, spirals, or offset lines be they vertical, horizontal, diagonal, or some combination thereof.

13. The stippled pickloid or cucumbic grip apparatus of claim 12 wherein the plurality of stipples is arranged to conform to the hand of a user thereby increasing tactility and grippability.

14. The stippled pickloid or cucumbic grip apparatus of claim 1 wherein the body portion and plurality of stipples are customizable for each user such that the arrangement of stipples and the choice of body portion material composition are selected by, and organized to be most ideal for, each individual user based on hand imaging, handgrip type, and squeeze resistance preference.

15. The stippled pickloid or cucumbic grip apparatus of claim 1 further comprising:
a second aperture disposed about the distal end;
wherein the pocket extends from, and connects, the apertures about the proximal and distal ends thereby forming a throughway.

16. The stippled pickloid or cucumbic grip apparatus of claim 15 further comprising a compressive sleeve lining the pocket wall extending from, and connecting, the first and second apertures thereby tautly engaging any item placed therein with at least a minimum of force to keep it in stationary operational engagement.

17. The stippled pickloid or cucumbic grip apparatus of claim 1 further comprising a valve about the distal end such that fluid has an ingress and egress.

18. The stippled pickloid or cucumbic grip apparatus of claim 1 further comprising a band about the proximal end that is permanently affixable to the exterior surface of any object being placed into the pocket.

19. The stippled pickloid or cucumbic grip apparatus of claim 1 further comprising:
a plurality of additional raised features disposed along the exterior surface;
wherein the plurality of additional raised features are shaped, sized, and formed to resemble ingredients present during pickling, such as peppercorns, bits of vegetables, flakes, herbs, spices, and garlic.

20. The stippled pickloid or cucumbic grip apparatus of claim 19 wherein the body portion, plurality of stipples, and plurality of additional raised features are customizable for each user such that the arrangement of stipples and features along with the choice of body portion material composition are selected by, and organized to be most ideal for, each individual user based on hand imaging, handgrip type, and squeeze resistance preference.
